(19) United States
(12) Patent Application Publication
(10) Pub. No.: US 2009/0141132 A1
(43) Pub. Date: Jun. 4, 2009

(54) Instrumentation for image acquisition from biological and non-biological assays

(75) Inventors: Paul V. Lehmann, Cleveland Heights, OH (US); Alexey Y. Karulin, Mayfield Heights, OH (US); Virgilio B. Velasco, Solon, OH (US); Thomas Oliver Kleen, Shaker Heights, OH (US)

Correspondence Address: D. Benjamin Borson;Borson Law group, 1320 Wilson Pass Rd. Suite 490, Concord, CA, 94520-5232, US

(73) Assignee: Cellular Technology ltd., Cleveland, OH (US)

(21) Appl. No.: 11/658,420

(22) PCT Filed: Jul. 25, 2005
(86) PCT No.: PCT/US05/26435

§ 371 Date: Feb. 2, 2009

(51) Int. Cl. H04N 5/225; G06K 9/00

(52) U.S. Cl. 348/207.99; 382/128

(57) ABSTRACT

Embodiments of this invention include flatbed scanners that have a surface and have a plurality of light sources. Alternatively, a single light source can be moved in two dimensions relative to an object placed on the surface of the scanner. Other embodiments include a scan head that is moveable in two dimensions relative to the flat bed of the scanner. Further embodiments include one or more polarizing filters to reduce glare and increase the quality of a captured image. Theses scanners can be used to capture images of enzyme linked immunosorbent assay (ELISA) substrates, plates having cultures thereon or other objects having irregular lower surfaces. Additional embodiments include methods for capturing images from ELISA substrates, bacterial culture plates, viral plaque assay plates and the like.

### CLAIM OF PRIORITY

This application claims priority to U.S. Provisional Patent Application No. 60/591,317, filed Jul. 26, 2004, Paul V. Lehmann, Alexey Y. Karulin, Virgilio B. Velasco, Jr. and Thomas Oliver Kleen, Inventors, titled “Instrumentation for Image Acquisition From Biological and Non-Biological Assays” (Attorney Docket No: CLTL 1014 U.S.0), incorporated herein fully by reference.

### FIELD OF THE INVENTION

This invention relates to devices and methods for capturing images formed in the course of biological of non-biological assays. These include, but are not limited to, ELISPOT assays, viral plaque assays, bacterial colony assays and transwell assays. In particular, this invention relates to methods and devices for more accurately illuminating irregular surfaces for computerized image analysis.

### BACKGROUND

Enzyme-linked immunospot assays (also known as “ELISA spot” assays or “ELISPOT” assays) have been developed to assay for immunoglobulins from B-lymphocytes (“B-cells”) (see Sedgwich, J. D. and Holt, P. G., “A solid-Phase Immunoenzymatic Technique for the Enumeration of Specific Antibody-Secreting Cells,” J. Immunol. Methods 57:301-309 (1983); Mazer, B. D. et al, “An ELISA Spot Assay for Quantitation of Human Immunoglobulin Secreting Cells,” J. Allergy Clin. Immunol. 88:235-243 (1991), both references incorporated herein in their entirety. In a conventional B-cell ELISA spot assay, commercially available flat-bottomed plates are coated overnight with antigen or animal antibody (a “secondary antibody”). In the case where a secondary antibody is used, it is typically an “anti-antibody” capable of specifically recognizing an antibody (“primary antibody”) from another species. For example, goat, rabbit or other non-human antibodies that are reactive with human IgG, IgE, IgM, etc. can be used to bind to the human antibody. In a typical B-cell assay, after overnight incubation, B cells are introduced into the wells. Following a sufficient culture period, during which time antibody is secreted by the B-cells and binds to the secondary antibody attached to the wells. The wells are then washed free of cells and an antibody-enzyme conjugate is added. The antibody of the antibody-enzyme conjugate is selected to bind specifically with either the primary or secondary antibodies in the wells. The plates are then washed to remove non-specifically bound antibody-enzyme conjugate, and then a substrate for the enzyme is added. The substrate is selected to produce a colored product, that when produced, can be substrate is selected to produce a colored product, that when produced, can be visualized using a microscope. Using such methods, the lowest amount of detectable primary antibody is typically in the range of about 10 to about 50 picograms (see Renz, H. et al., “Enhancement of IgE Production by Anti-CD40 Antibody in Atopic Dermatitis,” J. Allergy Clin. Immunol. 93:658-668 (1994)).

It has been more difficult to use ELISPOT methods to detect analytes from individual cells, such as T-lymphocytes (“T-cells”). Such assays would be very valuable in detecting and staging certain T-cell mediated diseases, such as HIV. Unfortunately, the numbers of T-cells is low, their responsiveness is relatively weak and the materials produced typically have a short half-life. Furthermore, T-cells are quite heterogeneous, and unlike B-cells, which typically are present in large numbers as clones, T-cells do not produce the same products under the same conditions. Therefore, development of new methods for detecting T-cell products has been undertaken. However, recently, ELISPOT methods have been useful in detection and quantification of analytes such as T-cell cytokines (see U.S. Pat. No. 6,410,252 herein incorporated fully by reference). As can be appreciated from the above patent, responses of individualized cells can be detected and quantified using ELISPOT methods. Unfortunately, prior art ELISPOT methods are relatively slow to analyze, at least partially because it is necessary to monitor a large number of different spots on a surface to obtain reliable information. This means that ELISPOT methods for detecting individualized responses (e.g., individualized T-cells, viral plaque assays and the like) are not rapid and are subject to potentially large sampling errors.

It is desirable to increase the throughput of ELISPOT assays to decrease the time needed to detect and/or quantify products from individual cells. In some cases, computerized analysis of ELISPOT images has improved throughput and provided increased reliability and accuracy. Computerized analysis may involve the acquisition of an image from a surface on which the assay has been performed. For example, for detection of certain analytes, membranes have been used to localize the analyte and hold it in place for further processing steps. With subsequent binding of an enzyme linked to an antibody specific for the analyte, and proper development of a colored reaction product, areas having the analyte can be visualized as “spots.”

It can be appreciated however, that accurate, quantitative measuring of such spots can be difficult. One type of solution has been the use of conventional image scanners to capture and digitize an image for further analysis. FIG. 1 depicts a scanner 100 of the prior art. A document 104 to be scanned is placed on a transparent surface 108 over the imaging apparatus 112. A light source 116 projects light upwards (upwards arrows) through transparent surface 108 and onto document 104. Light reflected from document 104 passes downward through transparent surface 108, then through aperture 106, then is reflected off of mirrors 120, 124, and 128. The light then passes through lens 132, filter 136 and is then sensed in image sensor 140.

FIG. 2 depicts variance in radiance obtained from an object having an uneven surface. A object to be scanned 117 is placed on transparent surface 108 and is illuminated by light source 116. Light from light source 116 passes through transparent surface 108 (arrow) and illuminates a portion of the object to be illuminated 117 at the point shown (dot). Due to the uneven surface of 117, the reflected light beam 119 appears an angle θ with respect to incident light beam from light source 116. Because of the uneven surface of 117, angle θ may vary from one part of 117 to another part of 117, thereby providing a variation in radiance. Such variance can cause poor reproducibility of the intensity of a captured image. For example, computerized analysis is subject to errors resulting from poor translation of an original test substrate with a spot into a digitized image for further analysis. One problem has been related to poor, uneven illumination of a surface having a spot thereon.

It is therefore desirable to provide methods for accurately and reproducibly capturing an image from a surface, such as those used for ELISPOT assays, even if the surface is irregular. Applications of these methods need not be limited to ELISPOT assays because the same principles can be used to capture images produced by viral plaque assays, bacterial colony assays, transwell assays and other assays for which objects can be visually detected.

### SUMMARY OF THE INVENTION

Certain embodiments of this invention use flatbed scanner technology to acquire digital images of objects formed on surfaces, such as membranes on the bottom of ELISPOT plates. These plates cannot simply be placed facedown on the scanner though, since the surface to be viewed must be placed directly against the transparent window of the scanner. In certain embodiments, ELISPOT plates are typically about 0.5″ thick, which means that a membrane at the bottom of these plates would be positioned well above the scanner surface.

In other embodiments, one can use peelable membranes, or to punch out the sections of the membrane which contain the cell-generated spots. Having been detached from the plates, these membranes (or membrane sections) can be placed directly against the transparent surface of the scanner. The images formed on their surfaces in the course of an assay can thus be scanned.

Commercial flatbed scanners use a single lamp at any given time, and thus, the illumination of an uneven surface, such as a membrane, can be uneven. Thus, the visual intensity of a resulting digitized image can vary from location to location on the surface. This can and does lead to artifacts in computerized analysis and lead to incorrect results of ELISPOT assays.

Thus, in certain embodiments of this invention, the above problem as well as others can be decreased by the use of flatbed scanner that uses more than a single lamp to illuminate the target area, and/or uses a plurality of scan heads, and/or uses a lamp in a fashion that provides a variety of different paths across the surface for which capturing an image is desired. In further embodiments, a polarizing filter can be used to decrease glare and thereby improve the quality of the captured image. Other aspects of this invention include multiple scan heads or imaging sensors. These improvements can lead to significant improvements in the reproducibility and accuracy of ELISPOT assays.

In other embodiments, such a flatbed scanner can be used to capture images from surfaces other than membranes, such as viral plaque assays, bacterial growth media or transwell assays. More generally, flatbed scanners and image capture methods of this invention can be used to provide reliable information even if the surface is uneven.

### BRIEF DESCRIPTION OF THE FIGURES

This invention is described with reference to specific embodiment thereof. Other aspects and features of this invention can be understood with reference to the Figures, in which:

FIG. 1 depicts an illustration of typical components within a scan head of the prior art, and how they are used to sense light reflected from a document.

FIG. 2 depicts an illustration of how curvature in a target object can cause variations in the incidence angle θ, causing variations in the irradiance produced. In principle, for sufficiently oblique angles of incidence, the amount of irradiance may even approach zero.

FIG. 3 depicts an embodiment of this invention, in which the use of multiple light sources, illuminating the surface along different angles of incidence, provides more consistent irradiance on surfaces that are not strictly flat.

FIG. 4 depicts an embodiment of this invention showing how multidirectional lighting can produce more consistent irradiance in the case of two lamps of equal intensity, symmetrically distributed about the nominal surface normal.

FIG. 5 depicts a typical flatbed scanner of the invention having two lamps, showing that the scan head moves longitudinally, that is, along the major axis.

FIG. 6 depicts an embodiment of this invention wherein the scan head moves laterally (along the minor horizontal axis), instead of longitudinally.

FIG. 7 depicts another embodiment of this invention that uses a smaller scan head to move in any arbitrary horizontal direction.

FIG. 8 depicts use of an embodiment of the invention to capture an image from an irregularly shaped object in a well.

FIG. 9 depicts a photograph of a cell culture dish taken using a scanner of the prior art.

FIG. 10 depicts a photograph of the same cell culture dish as shown in FIG. 9, taken using a scanner of this invention.

FIGS. 11a-11c depict embodiments of the invention having one or more polarizing filters to capture an image from an irregularly shaped object in a well.

FIG. 12 depicts a schematic drawing of an embodiment of this invention for inverted use.

### DETAILED DESCRIPTION

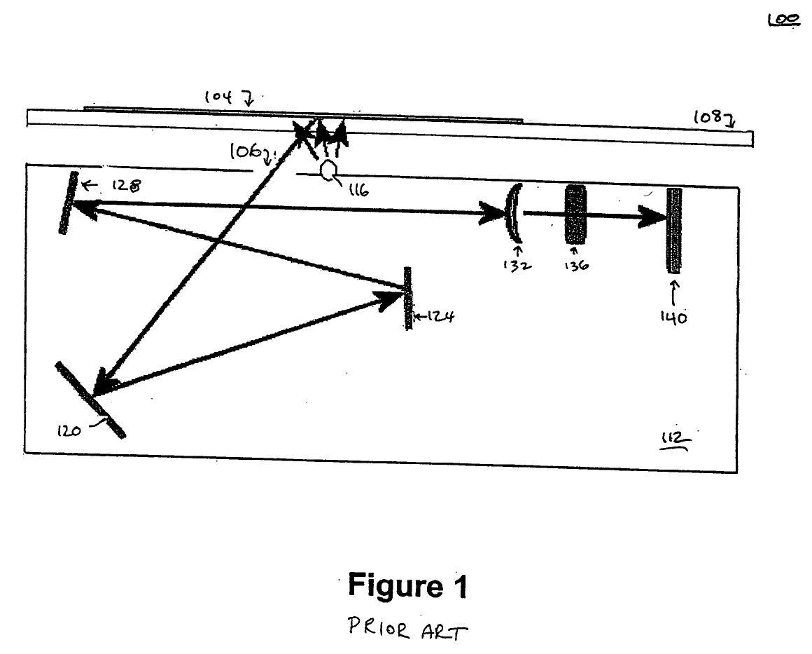

Commercial flatbed scanners read images from documents using a single lamp at a time and a scan head. The scan head consists of an imaging sensor, an arrangement of mirrors, a lens or lens arrangement, and an optical filter or set of filters. (For example, see FIG. 1). As the scan head moves across the document, light from the lamp is diffusely reflected from the document and into the aperture of the scan head. A set of mirrors then directs this light toward the lens or lens arrangement, the filter or filters, and the imaging sensor (More How Stuff Works by Marshall Brain, Wiley Publishing Co., pp. 220-221 (2003).

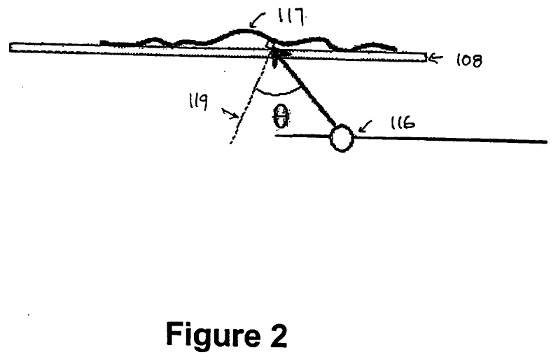

When scanning ELISPOT surfaces, however, their imperfect flatness of the surface can result in uneven illumination. This is due to the angle at which the light impacts the target surface (see FIG. 2). According to the Lambertian surface model, the radiance of a diffuse, non-mirrored surface is proportional to the cosine of the angle of incidence (Three Dimensional Computer Vision by Olivier Faugeras; Handbook of Pattern Recognition and Image Processing: Computer Vision by Tzay Y. Young). If the target surface is not flat, then some surfaces will be illuminated at more oblique angles, causing them to reflect light dimly; in fact, as the angle of incidence approaches 90° to the normal at that portion of the surface, the amount of irradiance would approach zero.

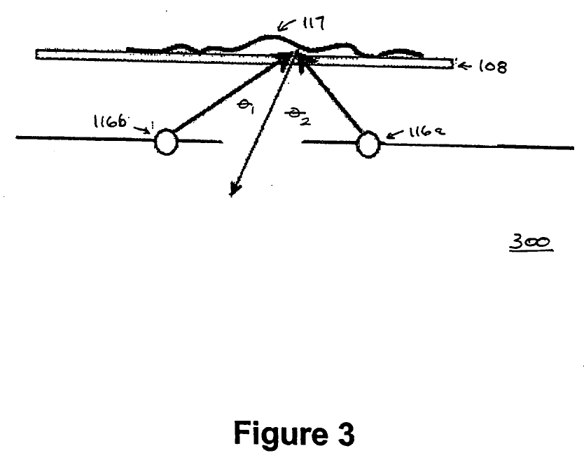

Therefore, in certain embodiments this problem can be mitigated by using two light sources to simultaneously illuminate the membrane from separate directions, thus providing two different angles of incidence. Tests have verified that by using lamps placed on opposite sides of the scan head aperture, the illumination can be made noticeably more even (see FIG. 3).

FIG. 3 depicts an embodiment of this invention 300 having two light sources 116a and 116b that illuminate object 117. As can be seen, the point at which light from sources 116a and 116b illuminate object 117 produces two angles, θ1 and θ2. Differences in radiance from the point on object 117 due to the uneven surface of object 117 can thereby be decreased.

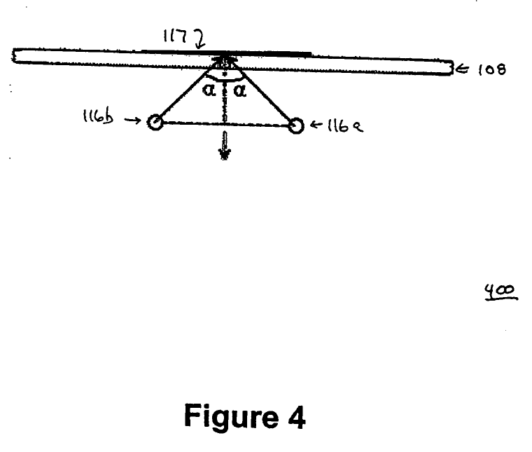

To further illustrate how multidirectional lighting can produce more even illumination, consider the example shown in FIG. 4. FIG. 4 depicts an embodiment 400 of this invention, wherein two light sources 116a and 116b illuminate an object 117 on a transparent surface 108. In this case, object 117 is relatively even, so if light sources 116a and 116b are of equal intensity and are situated such that (a) their distance from the point being scanned is equal, and (b) their incident rays both form an angle of α with the surface normal of a flat target at that point (downward arrow). Under such circumstances, the total radiance at that point is given by the expression

Lₜₒₜₐₗ(0)=2Iᵣ cos(α),

where Iᵣ is the irradiance produced at that point by either lamp. (Only a 2-dimensional case is illustrated here. In a 3-dimensional case, the radiance would be computed by multiplying the right-hand side of each equation with an additional cos(φ) factor. Since this constant factor would appear in all the radiance equations, it would not affect the final results.) If the document is tilted by some angle ±β, the radiance will vary as follows:

$$\begin{matrix}{L}_{total} ( \pm β ) = {I}_{r} [ cos ( α + β ) + cos ( α - β ) ] \\ = 2 {I}_{r} cos ( α ) cos ( β )\end{matrix}$$

The fractional amount of irradiance produced (i.e. Lₜₒₜₐₗ(β)/Lₜₒₜₐₗ(0)) thus ranges from cos(βₘₐₓ) to 1.0. In contrast, if only one bulb is activated, the radiance is given as follows:

Lₜₒₜₐₗ(0)=Iᵣ cos(α) if the target is untilted (i.e. β=0)

Lₜₒₜₐₗ(±β)=Iᵣ cos(α±β)

in which case the fractional amount of irradiance is expressed by the relationship:

$$\begin{matrix}{L}_{total} ( \pm β ) / {L}_{total} ( 0 ) = cos ( α \pm ( - β ) ) / cos ( α ) \\ = [ cos ( α ) cos ( β ) \pm sin ( α ) sin ( β ) ] / cos ( α ) \\ = cos ( β ) \pm tan ( α ) sin ( β )\end{matrix}$$

This fractional amount can thus encompass the following range of values:

[min{cos(β)−tan(α)sin(β), cos(β)+tan(α)sin(β)},

max (1.0, cos(β)−tan(α)sin(β), cos(β)+tan(α)sin(β)}]

As can be appreciated, min{cos(β)−tan(α)sin(β), cos(β)+tan(α) sin(β)}≦cos(β), and max{1.0, cos(β)−tan(α)sin(β), cos(β)+tan(α) sin(β)}≧1.0. Therefore, in this situation, a single lamp produces a greater range of relative variance in the radiance generated. Therefore, embodiments of this invention can improve a captured image by decreasing the variance of radiance, thereby providing greater accuracy of a captured image.

It is not intended that the present invention be limited by the nature of the light source employed. While commercial flatbed scanners have typically used a xenon lamp, a cold cathode fluorescent lamp or a standard fluorescent bulb, this invention could likewise employ light-emitting diode (LED) arrays, optical fiber lamps, infrared or ultraviolet lamps, optical lasers or any number of alternative light sources. Other embodiments could likewise use mirrors in place of one or more of these light sources. Additionally, it is not intended that the present invention be limited by the nature of the incident, reflected or re-emitted light. Other embodiments include the use of both visible and non-visible electromagnetic radiation (e.g., infrared, ultraviolet, microwave). For example, detection can be via fluorescent, absorption or via phosphorescence methods. Additionally, for some uses, a conventional ELISA assay need not be used. Rather, one can use methods and devices described in United States Provisional patent application titled “Microsphere Based Detection of Cellular Products, U.S. Application Ser. No. 60/489,451, filed Jul. 23, 2003, Paul Lehmann, inventor (Attorney Docket No: CLTL 1005 U.S.0 DBB) or as described in U.S. Utility Application titled “Nanoparticle and Microparticle Based Detection of Cellular Products, filed Jul. 22, 2004, Paul Lehmann and Alexey Karulin, inventors (Attorney Docket No: CLTL 1005 U.S.1 DBB), or as described in PCT International Application titled “Nanoparticle and Microparticle Based Detection of Cellular Products,” Filed Jul. 23, 2004, Paul Lehmann and Alexey Karulin, inventors (Attorney Docket No: CLTL 1005 WO0). Each of the above patent applications are incorporated herein fully by reference.

Nor is it intended that the present invention be limited by the precise number or arrangement of light sources used. Rather, it only requires that they illuminate the target from multiple directions (in a radial arrangement, for example). According to this invention, two, three, four, or more light sources could be used.

Similarly, this invention is not meant to be limited by the number of scan heads, the number of imaging sensors, or the nature of these sensors. Other embodiments could include two or more sensors that could be used to scan the same area multiple times. Alternately, they could be used to segment the target area into multiple sub-regions, each one scanned by a different sensor.

Additionally, this invention is not meant to be limited to the type of transparent surface employed. In some embodiments, glass surfaces, plastic surfaces or other material sufficiently transparent to permit light to pass there through in sufficient amount to permit detection and analysis of the object to be analyzed are suitable.

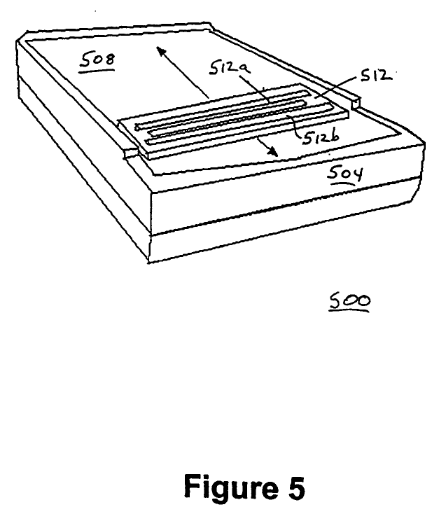

FIG. 5 depicts a flatbed scanner 500 of the invention having a plurality of light sources. Body 504 is depicted having a transparent surface 508 and scan head 512. Scan head 512 is depicted arranged in a perpendicular fashion to the major axis of the scanner and it moves longitudinally along the major axis (arrows). Two light sources 512a and 512b are depicted.

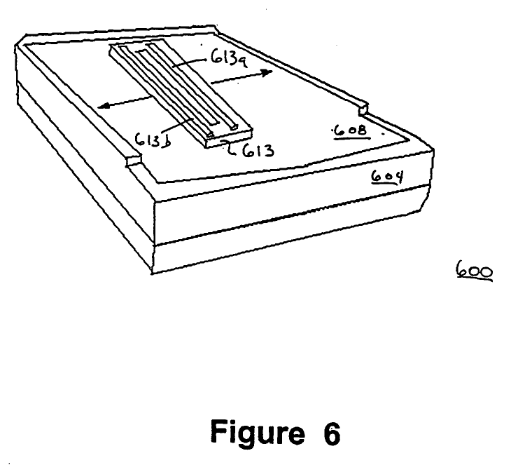

FIG. 6 depicts an embodiment 600 of this invention having scanner body 604 with transparent surface 608 and scan head 613. In this embodiment, scan head 613 can move in a direction perpendicular (arrows) to the major axis of the scanner. Scan head 613 has two light sources depicted, 613a and 613b.

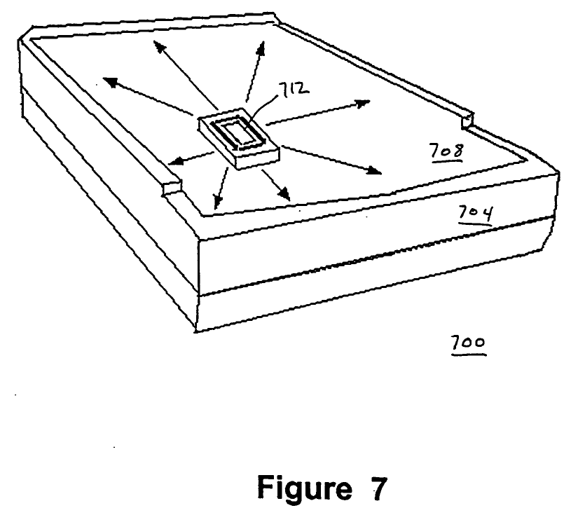

FIG. 7 depicts an alternative embodiment 700 of this invention having scanner body 704, transparent surface 708 and scan head 712. Scan head 712 is adapted to be moveable in any direction relative to transparent surface 708 (including directions depicted by arrows), thereby providing a mechanism for illuminating an object (not shown).

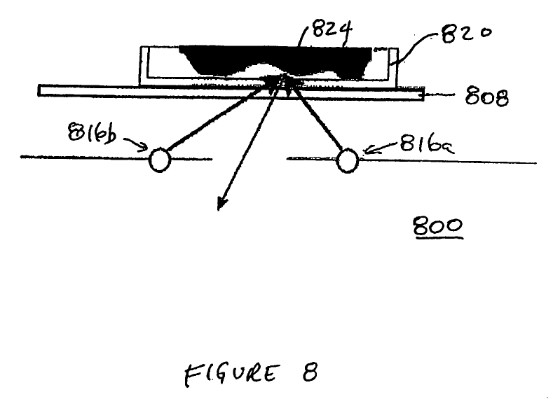

FIG. 8 depicts an embodiment 800 of this invention, in which the scanner (not fully shown) has transparent surface 808 and two light sources 816a and 816b. An assay container 820, such as a petri dish or well of a multiwell plate is shown. Within assay container 820, an object to be scanned 824 is a structure or texture formed during an assay and is depicted having an irregular lower surface. Light from sources 816a and 816b (upwardly directed arrows) illuminate a portion of object 824 resulting in a reflected beam of light (downward arrow), which is then captured by an image capture device (not shown).

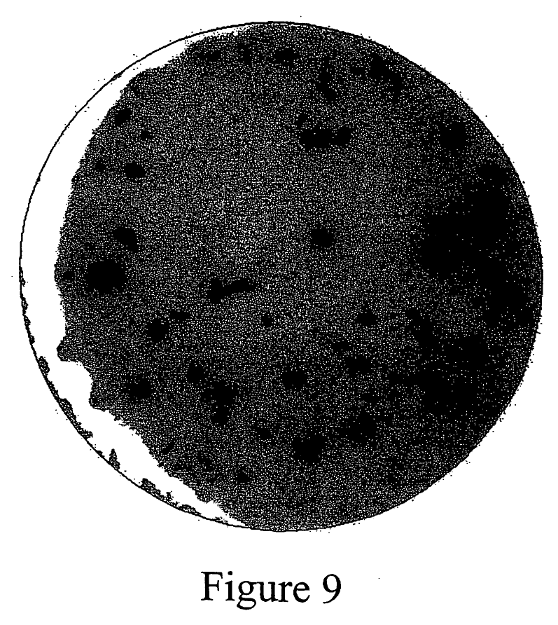

FIG. 9 depicts an image of a well having developed ELISA spots thereon made using prior art scanner. On the left side of the Figure, areas of uneven illumination appear to be “washed out” and as a result, the scanned image has an irregular image.

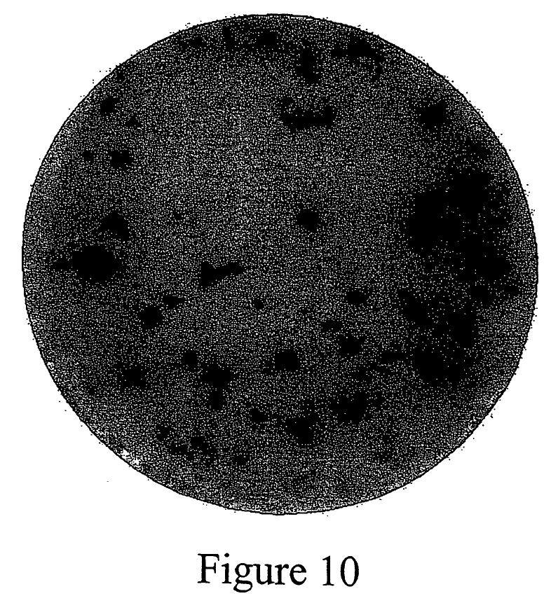

FIG. 10 depicts an image of the same well as shown in FIG. 9, taken using a scanner of this invention. The portion of FIG. 9 that appeared uneven or washed out has been more evenly illuminated, thereby reducing the defect in the image.

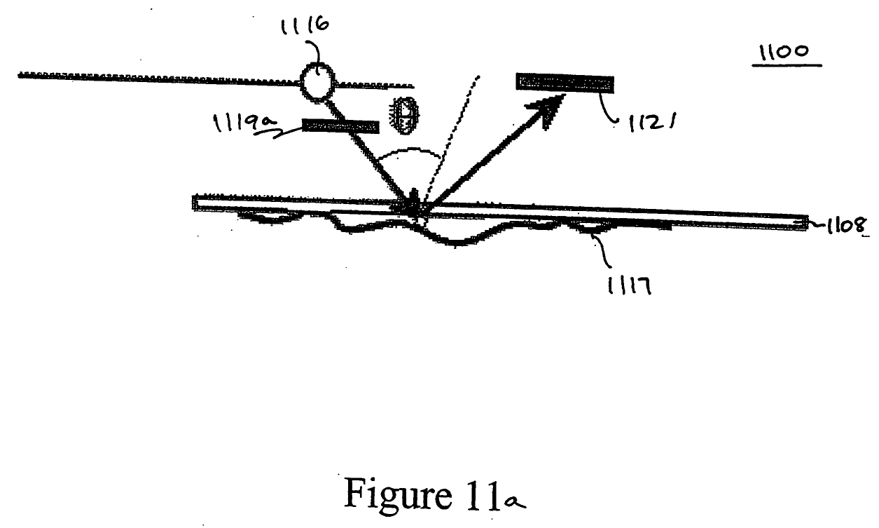

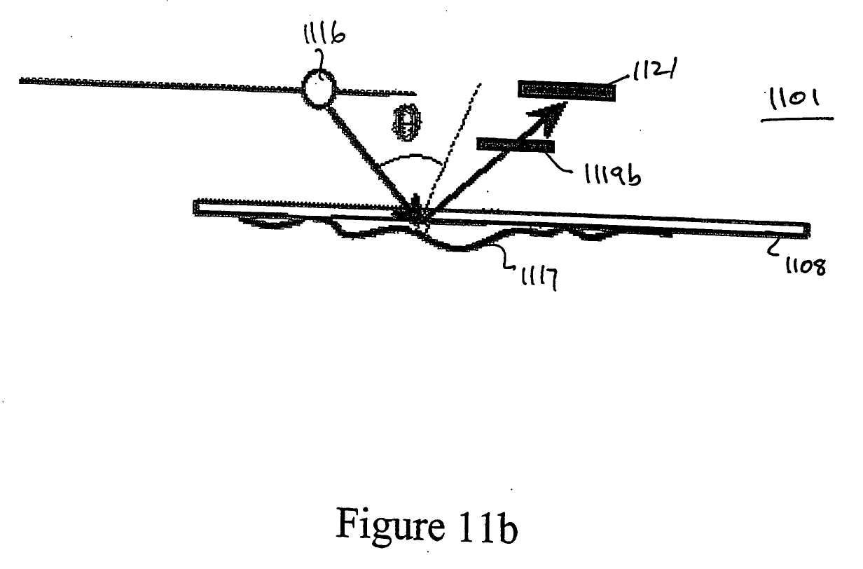

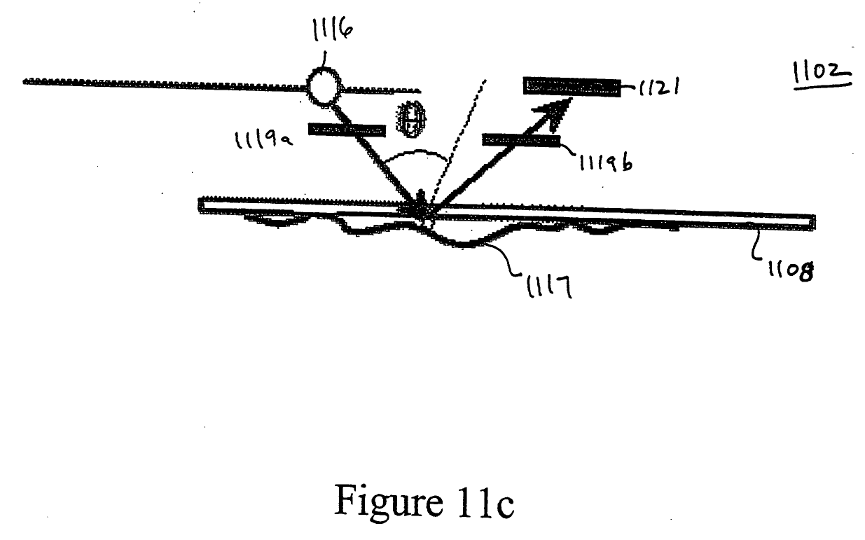

Further embodiments include use of polarizing filters to reduce glare from surfaces, thus allowing the images to be seen more clearly. These applications would include, but are not limited to, situations in which the objects to be scanned are within clear containers such as Petri dishes or 96-well polystyrene culture plates. The embodiments would reduce the amount of glare produced by the container, thus permitting a clearer image of the scanned object. In one such embodiment, a polarizing filter can be placed between a light source and an object to be scanned. By filtering out the components of the incident light, which contribute most heavily to glare reflections, the total amount of glare can be reduced. (See FIG. 11a). A further embodiment would employ a polarizing filter between the object to be scanned and the image sensor (or detector) (e.g., FIG. 11b). In another embodiment, both of these techniques can be combined; that is, polarizing filters can be placed between a light source and the object to be scanned, and another polarizing filter can be placed between the object and an imaging sensor (e.g., FIG. 11c). In this approach, the filters would be oriented such that their polarizing directions are at a non-zero angle from each other (e.g. at 90°). (See Solution200: Enlightened Through Experience by CCS Inc, © 2000.) This embodiment would thus directly reduce the amount of glare produced, as well as the components of incident light, which contribute most significantly to the glare.

FIGS. 11a-11c depict schematic drawings of embodiments having polarizing filters. FIG. 11a depicts an embodiment 1100 of this invention having a polarizing filter. A portion 1108 of a well has an irregular object 1117 therein. Lamp 1116 directs a beam of incident light (downward arrow) through polarizing filter 1119a and then to a portion of object 1117. Reflected light (upward arrow) having an angle θ relative to the normal at that portion of object 1117 reaches detector 1121, where an image is produced.

FIG. 11b depicts an alternative embodiment 1101 of this invention having a polarizing filter. A portion 1108 of a well has an irregular object 1117 therein. Lamp 1116 directs a beam of incident light (downward arrow) to a portion of object 1117. Reflected light (upward arrow) passes through polarizing filter 1119b and then reaches detector 1121, where an image is produced.

FIG. 11c depicts an alternate embodiment 1102 of this invention having two polarizing filters. A portion 1108 of a well has an irregular object 1117 therein. Lamp 1116 directs a beam of incident light (downward arrow) through polarizing filter 1119a and then to a portion of object 1117. Reflected light (upward arrow) passes through polarizing filter 1119b and then reaches detector 1121, where in image is produced.

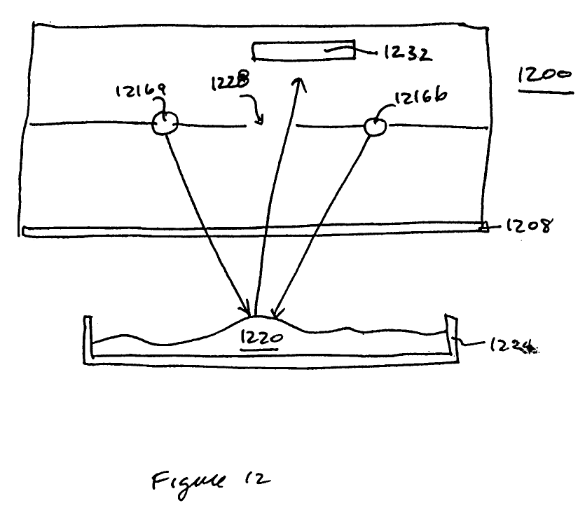

FIG. 12 depicts a schematic drawing of an inverted embodiment 1200 of this invention suitable for capturing images of objects that cannot conveniently be placed on top of the transparent material of the scanner surface. Scanner 1200 has a lower transparent surface 1208 two lamps 1216a and 1216b that illuminate object 1220 in vessel 1224 from above (downward arrows). Light reflected from object 1220 passes upward through slit 1228 and back to detector 1232.

However, this invention is not to be limited to any particular direction of motion, or any given arrangement or orientation of the scan head and its light sources. Additional embodiments would include scanners in which the sensor head is parallel to the major axis, and moves laterally (that is, perpendicular to this axis). Still other embodiments could incorporate scan heads that can move in any horizontal direction (that is, any combination of lateral and longitudinal motions).

Additionally, it is not intended that the present invention be limited by the type of assay performed. Although this discussion has hitherto been described with the use of ELISPOT or other spot assays, the same or similar techniques can be used with various forms of viral plaque assays, transwell assays, bacterial colony assays or any other assay in which images are formed on a relatively (but perhaps imperfectly) flat surface.

In viral plaque assays, for example, patterns are formed in a cell culture contained within some nutrient medium, such as agar. By propagating within the cell cultures, the viruses generate zones of cell destruction known as plaques. These plaques can be detected visually, sometimes with the naked eye, and sometimes through other techniques such as staining, microscopy, hemadsorption or immunofluorescence, for example. By detecting and evaluating these plaques, a researcher can gauge virus activity and effectiveness, as well as enumerate effective viruses (See Biology of Microorganisms, 8^{th} Edition, M. T. Madigan, J. M. Martinko and J. Parker, © 1997, Prentice Hall, pp 255-257; Principles of Microbiology and Immunology, Bernard D. Davis et al., © 1968, Harper and Row, Publishers, pp. 660-661). Because viral plaques may be formed within the agar at any depth, illuminators and detectors of this invention can be especially useful to capture images of different plaques.

In bacterial colony assays, the patterns are formed within culture media that has been inoculated with bacterial cells. This allows the cells to reproduce and form bacterial colonies within and/or on the surface of the media. When the colonies are sufficiently large, they are usually visible to the naked eye, which allows researchers to determine the number of colonies formed. In addition, various visual characteristics of the colonies, such as shape, size, pigmentation, and opacity, can be used to help determine the type of bacterium present (See Biology of Microorganisms, 8^{th} Edition, M. T. Madigan, J. M. Martinko and J. Parker, © 1997, Prentice Hall, pp 24-25, 156-157; Bacteria in Biology, Biotechnology and Medicine, Third Edition, Paul Singleton, © 1995, John Wiley & Sons, Inc. pp. 37-38; Microorganisms in Our World, Ronald M. Atlas, © 1995, Mosby-Year Book, Inc. pp. 82-83, 292-294). The methods described herein can be used to record images formed by the bacterial colonies in question, so that the number and visual characteristics of the colonies can be evaluated.

Patterns can likewise be visually detected in transwell assays, in which cells are placed within wells that have porous membranes at their bottoms. The cells are incubated, during which they can migrate to the underside of the well membranes. After incubation, the cells that remain on the upper surface of the membranes are removed. (The migrated cells can be stained for visual clarity, either before or after removal of the unmigrated cells.) The cells that migrated to the underside can then be visually detected, using the methods described herein. (See Cytokine/Chemokine Manual: Genes->Proteins->Cells, by B D Pharmingen, © June 1999; Annabi, B. et al, “Calmodulin Inhibitors Trigger the Proteolytic Processing of Membrane Type-1 Matrix Metalloproteinase, But Not Its Shedding in Glioblastoma Cells,” Biochem. J. 359:325-333 (2001); Shin, E-Y, Kim, S-Y and Kim, E-G, “c-Jun N-terminal Kinase is Involved in Motility of Endothelial Cell,” Experimental and Molecular Medicine, 33(4):276-283, December 2001).

Furthermore, this invention is meant to encompass the use of assay plates and other containers in which images can be viewed from the bottom, for example, through transparent plates or membranes. If desired, additional materials such as white emulsions can be added to provide additional contrast between the object and it's surrounding to provide accurate capturing of an image.

Scanners of this invention and methods for their use can be used in industries including medical diagnosis, biomedical research and any other industry in which reproducible, high quality image capture of irregular objects is desired.

This invention is described with reference to specific embodiments thereof. It can be appreciated that workers of skill in the art can produce other embodiments and variants of the invention. All of those variants are considered to be part of this invention.

All of the references cited herein are incorporated fully by reference in their entirety.

We claim:

1. A device for capturing an image of an object, comprising:
a body having a surface thereon;
a plurality of light sources moveable parallel to said surface; and
an image capture mechanism adapted to receive and store an image produced by light reflected from or emitted from said object.

2. The device of claim 1, wherein said plurality of light sources are adapted to traverse said surface in a direction parallel to a major axis of said device.

3. The device of claim 1, wherein said plurality of light sources are adapted to traverse said surface in a direction perpendicular to a major axis of said device.

4. The device of claim 1, wherein said plurality of light sources are adapted to traverse said surface in a direction neither perpendicular oblique to said major axis of said device.

5. A device for capturing an image of an object, comprising:
a body having a surface thereon;
a light source moveable in two dimensions in parallel to said surface; and
an image capture mechanism adapted to receive and store an image produced by light reflected from said object.

6. The device of claim 1, wherein said device has a polarizing filter between said object and said image capture mechanism.

7. The device of claim 6, wherein said object is selected from the group consisting of enzyme linked immunosorbent assay substrates, wells from a multiwell plate, petri dishes, substrates for viral plaque assays and substrates for bacterial culture.

8. A method for detecting an object, comprising the steps of:
(a) providing a device having:
a body having a surface thereon;
a plurality of light sources moveable parallel to said surface; and
an image capture mechanism adapted to receive and store an image produced by light reflected from an object on said surface;
(b) placing said object on said surface;
(c) illuminating said object; and
(d) capturing an image of said illuminated object.

9. The method of claim 8, wherein said step of determining comprises analyzing said image using a processor.

10. The method of claim 8, wherein said object is an enzyme-linked immunosorbent assay substrate.

11. The method of claim 8, wherein said object comprises a culture medium and said spot is created by at least one bacterium.

12. The method of claim 8, wherein said object comprises a viral plaque assay substrate and said spot is created by presence of viruses.

13. The method of claim 8, wherein said object is in a transwell assay device.

14. A method for detecting a spot, comprising the steps of:
(a) providing a device having:
a scan head;
a plurality of light sources moveable parallel to said surface; and
an image capture mechanism adapted to receive and store an image produced by light reflected from an object on said surface;
(b) placing said scan head over an object to be detected on said surface;
(c) capturing an image of said object; and
(d) determining whether said object comprises a spot.

15. A device for capturing an image of an object, comprising:
a scan head moveable with respect to said object, said object having an irregularly planar surface;
a light source moveable in two dimensions relative to said planar surface of said object; and
an image capture mechanism adapted to receive and store an image produced by light reflected from or emitted from said object.

16. The device of claim 15, wherein said device is adapted to be placed above said object.

17. A method for capturing an image of an object, comprising:
a) providing a device, comprising:
a scan head moveable with respect to said object, said object having an irregularly planar surface;
a light source moveable in two dimensions relative to said planar surface of said object; and
an image capture mechanism adapted to receive and store an image produced by light reflected from or emitted from said object;
b) placing said device above said object; and
c) capturing an image of said object.

18. The method of claim 17, wherein said object produces a spectrographic signal selected from the group consisting of absorption, fluorescence and phosphorescence.

19. The method of claim 18, wherein said spectrographic signal is produced using a detection particle.

20. The method of claim 8, wherein said illuminated object produces a spectrographic signal selected from the group consisting of absorption, fluorescence and phosphorescence.

21. The method of claim 20, wherein said spectrographic signal is produced using a detection particle.

22. The device of claim 1, further comprising a polarizing filter placed between a light source and said object.

23. The device of claim 1, further comprising a polarizing filter placed between said object and said image capture mechanism.

24. The device of claim 1, further comprising a polarizing filter placed between a light source and said object, and another polarizing filter placed between said object and said image capture mechanism, and wherein a direction of polarization of one of said polarizing filters is at a non-zero angle with respect to a direction of polarization of said other polarizing filter.
